(19) United States
(12) Patent Application Publication
(10) Pub. No.: US 2003/0204705 A1
(43) Pub. Date: Oct. 30, 2003

(54) Prediction of branch instructions in a data processing apparatus

(76) Inventors: William H. Oldfield, Cambridge (GB); Alexander E. Nancekievill, Cambridge (GB)

Correspondence Address: NIXON & VANDERHYE P.C., 8th Floor, 1100 North Glebe Road, Arlington, VA, 22201, US

(21) Appl. No.: 10/134,649

(22) Filed: Apr. 30, 2002

(51) Int. Cl. G06F 9/00

(52) U.S. Cl. 712/207; 712/239

(57) ABSTRACT

The present invention provides a data processing apparatus and method for predicting branch instructions in a data processing apparatus. The data processing apparatus comprises a processor for executing instructions, a prefetch unit for prefetching instructions from a memory prior to sending those instructions to the processor for execution, and branch prediction logic for predicting which instruction should be prefetched by the prefetch unit. The branch prediction logic is arranged to predict whether a prefetched instruction specifies a branch operation that will cause a change in instruction flow, and if so to indicate to the prefetch unit a target address within the memory from which a next instruction should be retrieved. The instructions include a first instruction and a second instruction that are executable independently by the processor, but which in combination specify a predetermined branch operation whose target address is uniquely derivable from a combination of attributes of the first and second instruction. The data processing apparatus further comprises target address logic for deriving from the combination of attributes the target address for the predetermined branch operation, the branch prediction logic being arranged to predict whether the predetermined branch operation will cause a change in instruction flow, in which event the branch prediction logic is arranged to indicate to the prefetch unit the target address determined by the target address logic. Accordingly, even though neither the first instruction nor the second instruction itself uniquely identifies the target address, the target address can nonetheless be uniquely determined thereby allowing prediction of the predetermined branch operation specified by the combination of the first and second instructions.

### BACKGROUND OF THE INVENTION

1. Field of the Invention

The present invention relates to techniques for predicting branch instructions in a data processing apparatus.

2. Description of the Prior Art

A data processing apparatus will typically include a processor core for executing instructions. Typically, a prefetch unit will be provided for prefetching instructions from memory that are required by the processor core, with the aim of ensuring that the processor core has a steady stream of instructions to execute, thereby aiming to maximise the performance of the processor core.

To assist the prefetch unit in its task of retrieving instructions for the processor core, prediction logic is often provided for predicting which instruction should be prefetched by the prefetch unit. The prediction logic is useful since instruction sequences are often not stored in memory one after another, since software execution often involves changes in instruction flow that cause the processor core to move between different sections of code depending on the task being executed.

When executing software, a change in instruction flow typically occurs as a result of a “branch”, which results in the instruction flow jumping to a particular section of code as specified by a target address for the branch. The branch can optionally specify a return address to be used after the section of code executed by the branch has executed.

Accordingly, the prediction logic can take the form of a branch prediction unit which is provided to predict whether a branch will be taken. If the branch prediction unit predicts that a branch will be taken, then it instructs the prefetch unit to retrieve the instruction that is specified by the target address of the branch, and clearly if the branch prediction is accurate, this will serve to increase the performance of the processor core since it will not need to stop its execution flow whilst that instruction is retrieved from memory. Typically, a record will be kept of the address of the instruction that would be required if the prediction made by the branch prediction logic was wrong, such that if the processor core subsequently determines that the prediction was wrong, the prefetch unit can then retrieve the required instruction.

It will be appreciated that any particular instruction will only have a predetermined number of bits for specifying that instruction and the attributes relevant to that instruction. For a branch instruction, one of the attributes that needs to be specified is the target address for the branch. Typically, this target address is expressed as an offset value to be applied to a program counter value for the current instruction in order to produce the target address. Since branches may typically involve a significant jump through the code, a significant number of bits may be required to uniquely identify the offset value.

When the number of bits required to specify the offset value are not available within the instruction itself, it is known instead to identify within the instruction a register which is then arranged to contain the offset value. However, this can impact on performance, since it requires the use of other instructions to ensure that the appropriate offset value is placed in the required register prior to execution of the branch instruction. Furthermore, in the context of prediction, it means that the prediction logic is typically unable to make any prediction on such a branch instruction, since it will typically not have access to the contents of the register specified within the branch instruction, and accordingly cannot make any prediction of the target address.

Instead of specifying the target address (or the offset value) by referring to a register, an alternative is to directly specify the target address (or the offset value) within the branch instruction itself. This typically improves performance, since a register does not need to be accessed, and as mentioned above then enables the branch prediction logic to make a prediction on that branch instruction, since the branch prediction logic can determine the target address. However, as mentioned above, the instructions of certain instruction sets do not have enough bits available to enable the target address (or the offset value) to be specified.

In Complex Instruction Set Computers (CISC) based systems, this problem can be alleviated by allowing variable length instructions, and hence allowing a branch instruction to include more bits than other instructions. However, in Reduced suction Set Computer (RISC) based systems, the basic design principle is that the instructions should all be of the same length, since variable length instructions add significantly to complexity. Hence, for any particular RISC instruction set, all of the instructions in that instruction set should have the same number of bits.

An example of a RISC based instruction set is the Thumb instruction set developed by ARM Limited. Each instruction in the Thumb instruction set is specified by 16 bits. When specifying a branch instruction in 16 bits, there is typically insufficient space to specify the target address (or offset value) within the instruction itself. Accordingly, it is possible as described earlier to instead make reference within the branch instruction to a register that will contain the target address (or offset value), but as identified this then prevents the branch prediction logic predicting that branch instruction.

An alternative that has been developed within Thumb is to define two instructions that are executable independently by the processor, but which in combination specify a branch operation. The first instruction in the pair adds an “immediate” value specified within that instruction to the program counter value, and places the result in a particular register of the register bank. A second instruction in the pair then retrieves the content of the that register and adds it to a shifted version of an “immediate” value specified in that second instruction to produce the target address. By using the two instructions, this enables a larger offset value to be specified than would be possible using a single instruction.

However, from the above, it can be seen that the first instruction is not specifying a branch, and hence will not be predicted by the branch prediction logic. Furthermore, the branch prediction logic is unable to predict the second instruction, since that instruction requires access to a specific register of the register bank in order to determine the target address, and the branch prediction logic will typically not have access to that register, and hence cannot predict the target address.

Hence, although this pair of instructions can yield performance benefits, it does not assist in facilitating prediction of the branch.

It is an object of the present invention to provide a technique for enabling branch prediction of a branch operation specified by more than one instruction.

### SUMMARY OF THE INVENTION

Viewed from a first aspect, the present invention provides a data processing apparatus, comprising: a processor for executing instructions; a prefetch unit for prefetching instructions from a memory prior to sending those instructions to the processor for execution; branch prediction logic for predicting which instructions should be prefetched by the prefetch unit, the branch prediction logic being arranged to predict whether a prefetched instruction specifies a branch operation that will cause a change in instruction flow, and if so to indicate to the prefetch unit a target address within said memory from which a next instruction should be retrieved; the instructions including a first instruction and a second instruction that are executable independently by the processor, but which in combination specify a predetermined branch operation whose target address is uniquely derivable from a combination of attributes of the first and second instruction, the data processing apparatus further comprising: target address logic for deriving from said combination of attributes the target address for the predetermined branch operation; the branch prediction logic being arranged to predict whether the predetermined branch operation will cause a change in instruction flow, in which event the branch prediction logic is arranged to indicate to the prefetch unit the target address determined by the target address logic.

The present invention is concerned with the problem of predicting a branch specified in combination by a first instruction and a second instruction that are executable independently by the processor. As mentioned earlier, the branch prediction logic is unable to make a prediction due to the fact that neither instruction uniquely identifies the target address. However, the inventors of the present invention realised that the target address is uniquely derivable from a combination of attributes of the first and second instruction. Hence, in accordance with the present invention, the data processing apparatus is arranged to further comprise target address logic for deriving from the combination of attributes of the first and second instruction the target address for the predetermined branch operation specified in combination by the first and second instructions. The branch prediction logic is then arranged to predict whether the predetermined branch operation will cause a change in instruction flow, in which event the target address calculated by the target address logic is made available to the branch prediction logic to enable the branch prediction logic to indicate to the prefetch unit the target address for the predetermined branch operation.

Hence, whilst in the normal processing of the first and second instructions by the processor, the target address only becomes uniquely determined once the commit point of the second instruction is reached, at which point there is no point in performing any prediction since no performance benefit can be gained at that time, the data processing apparatus of the present invention is able effectively to “stitch together” the relevant attributes of the first and second instruction in order to enable an earlier derivation of the target address so as to allow prediction of the predetermined branch operation to be made.

It will be appreciated by those skilled in the art that the combination of attributes of the first and second instruction that are required to uniquely derive the target address may take a variety of forms. However, in preferred embodiments, the combination of attributes comprises the address of the first instruction and predetermined operands of the first and second instructions, the address of the first instruction being specified by a program counter value, and the target address logic including adder logic for generating the target address by adding the program counter value to an offset value derived from the predetermined operands of the first and second instructions.

More particularly, in preferred embodiments, the target address logic is arranged to use the predetermined operands of one of the first and second instructions in the determination of the most significant bits of the offset value, and to use the predetermined operands of the other of the first and second instructions in the determination of the least significant bits of the offset value.

It will be appreciated that there are a variety of different ways in which the predetermined operands may be used to generate the offset value to be added to the program counter value. However, in preferred embodiments, the predetermined operands of the first instruction are used in the determination of the most significant bits of the offset value, and the target address logic is arranged to shift the predetermined operands of the first instruction left by a predetermined number of bits to produce a first value, to sign extend the first value to produce a second value having the same number of bits as the program counter, and to add the predetermined operands of the second instruction to the second value to produce a third value from which the offset value is derived.

The actual derivation of the offset value from the third value will depend on the actual predetermined branch operation specified in combination by the first and second instructions. For example considering the earlier example of the Thumb instruction set developed by ARM Limited, a first predetermined branch operation is a Thumb BL operation which provides an unconditional sub-routine call to another Thumb routine. In this example, twice the predetermined operands of the second instruction are added to the second value to produce the third value, this in effect being equivalent to adding the predetermined operands of the second instruction shifted left by one bit to the second value, and setting the least significant bit to a zero value. The third value then specifies the offset value.

A second example of a predetermined branch operation specified in combination by a first and second instruction is the Thumb BLX (1) instruction, which provides an unconditional sub-routine call from a Thumb routine to an ARM routine (i.e. a call to a routine specified by the ARM instruction set rather than the Thumb instruction set). In this example, the above-described steps used for a Thumb BL instruction to derive the third value are also used for the Thumb BLX instruction, but for the Thumb BLX instruction, the resulting third value is forced to be word-aligned by clearing bit 1 of the third value in order to produce the offset value (i.e. in this example the least two significant bits are both forced to a zero value).

Due to the fact that the first instruction and the second instruction are executable independently by the processor, the processor does not require that the second instruction immediately follows the first instruction in its execution pipeline, and hence for example an interrupt may occur between execution of the first instruction and the second instruction without affecting execution of the predetermined branch operation. This is due to the fact that the result of the first instruction is in preferred embodiments stored within a register of the register bank, and interrupt procedures, instruction fetch aborts, data aborts, debug events, undefined instruction traps, and the like are written such that the contents of the register bank can be restored following their execution.

However, there will typically be no such guarantee that the internal logic of the target address logic is not corrupted by any intervening operations occurring between receipt of the first instruction and receipt of the second instruction. Accordingly, in preferred embodiments, the target address logic is arranged upon occurrence of the first instruction to store the predetermined operands of the first instruction, and if the instruction following the first instruction is the second instruction, to then generate the target address. Preferably, if the instruction following the first instruction is not the second instruction, then the target address logic will not be arranged to generate the target address, and accordingly in that instance the branch prediction logic would not be arranged to predict the predetermined branch operation. It will be appreciated by those skilled in the art that the target address logic could still be arranged in any event to generate the target address, but in the event that the instruction following the first instruction was not the second instruction, the target address logic would preferably be arranged to clarify by an associated control signal that the target address generated in that instance was not valid.

In preferred embodiments, the branch prediction logic comprises a static branch prediction logic, the static branch prediction logic incorporating the target address logic.

As will be appreciated by those skilled in the art, static branch prediction logic is arranged to make a prediction about the likely outcome of a branch operation only using information in the branch itself. In practice, this usually means using characteristics like the direction of the branch to make a prediction. As an example, backwards branches (i.e. branches that point to an instruction with a lower address) are typically found at the end of loops and are therefore generally considered to be taken more times than not taken, whereas forwards branches (i.e. branches that point to an instruction with a higher address) have a more likely probability of not being taken. Therefore, it is common that static branch prediction logic is arranged to predict backwards branches as taken and forwards branches as not taken. In addition, in preferred embodiments, certain branch operations, including the predetermined branch operation, are actually unconditional, and accordingly will always be predicted as taken. It is worth noting that such unconditional branch operations can still be considered as being predicted, since the derivation of their target address for use by the prefetch unit is being made speculatively ahead of actual execution by the processor.

In preferred embodiments, the processor is a pipelined processor of a processor core, the static branch prediction logic being located within the processor core such that it is arranged to issue the target address to the prefetch unit prior to committed execution of the second instruction by the processor. This enables the required subsequent instructions to be retrieved speculatively ahead of execution by the processor, thereby yielding significant performance benefits in situations where the branch is correctly predicted.

As will be appreciated by those skilled in the art, an alternative type of prediction to static prediction is so-called dynamic prediction. Dynamic prediction typically uses historical information about what has happened when a particular branch operation was previously evaluated to predict what will happen this time. In preferred embodiments, the data processing apparatus preferably comprises a dynamic branch prediction logic unit. More particularly, in preferred embodiments, the data processing apparatus further comprises a branch target cache for storing predetermined information about branch operations executed by the processor, the predetermined information including an identification of an instruction specifying a branch operation and a target address for the branch operation, the branch prediction logic comprising dynamic branch prediction logic arranged to determine with reference to the branch target cache whether a prefetched instruction is identified within the branch target cache, to predict whether that prefetched instruction specifies a branch operation that will cause a change in instruction flow, and if so to indicate to the prefetch unit the target address as specified in the branch target cache.

Since no historical information is available the first time a branch operation is seen, dynamic prediction circuitry nearly always partners static prediction circuitry which is arranged to handle this first case. Indeed, in preferred embodiments of the present invention, the branch prediction logic not only comprises the dynamic branch prediction logic, but also further comprises the earlier-mentioned static branch prediction logic.

In preferred embodiments, upon committed execution of the second instruction by the processor, the processor is arranged to issue a branch target cache signal identifying the predetermined information about the predetermined branch operation to cause an update of the branch target cache to take place, the processor being arranged to obtain the target address from the target address logic for inclusion in the branch target cache signal. Prior to the present invention, information about the predetermined branch operation would not be able to be added to the branch target cache, since the processor would determine that, due to the fact that it had had to calculate the target address with reference to the contents of a register in the register bank, it was unsafe to specify a target address to be included within the branch target cache (i.e. the processor would not be in a position to conclude that the target address would be a unique target address). However, in accordance with preferred embodiments of the present invention, the processor is arranged to obtain the unique target address as derived by the target address logic for inclusion in the branch target cache signal, and accordingly the predetermined branch operation can be identified by an entry in the branch target cache, thus enabling future occurrences of the predetermined branch operation to be predicted by the dynamic branch prediction logic.

In preferred embodiments, the branch target cache includes for each branch operation identified within the branch target cache historical information about previous execution of that branch operation by the processor for use by the dynamic prediction logic in predicting whether that branch operation will cause a change in instruction flow. In preferred embodiments, the historical information comprises one or more bits of data per branch operation, identifying a likelihood of whether the branch is to be taken based on a number of previous occurrences of that branch operation. In particular preferred embodiments, two bits of data per branch operation are specified encoding a likelihood of the branch being taken based on up to the last two occurrences of the branch operation.

It will be appreciated that the dynamic branch prediction logic may be an entirely separate unit to the processor or the prefetch unit. However, in preferred embodiments, the dynamic branch prediction logic is contained within the prefetch unit, to increase the speed of the dynamic prediction process.

Viewed from a second aspect, the present invention provides a method of predicting which instructions should be prefetched by a prefetch unit of a data processing apparatus, the data processing apparatus having a processor for executing instructions, and said prefetch unit being arranged to prefetch instructions from a memory prior to sending those instructions to the processor for execution, the instructions including a first instruction and a second instruction that are executable independently by the processor, but which in combination specify a predetermined branch operation whose target address is uniquely derivable from a combination of attributes of the first and second instruction, the target address specifying an address within said memory from which a next instruction should be retrieved, and the method comprising the steps of: i) deriving from said combination of attributes the target address for the predetermined branch operation; ii) predicting whether the predetermined branch operation will cause a change in instruction flow; and iii) if it is predicted at said step (ii) that the predetermined branch operation will cause a change in instruction flow, indicating to the prefetch unit the target address determined at said step (i).

### BRIEF DESCRIPTION OF THE DRAWINGS

The present invention will be described further, by way of example only, with reference to preferred embodiments thereof as illustrated in the accompanying drawings, in which:

FIG. 1 is a block diagram of a data processing apparatus in accordance with an embodiment of the present invention;

FIG. 2 is a flow diagram of the process performed by the static prediction decoder of FIG. 1 to calculate an immediate value;

FIG. 3 illustrates the form of a branch instruction used in embodiments of the present invention; and

FIG. 4 is a diagram schematically illustrating the contents of the Branch Target Address Cache (BTAC) of preferred embodiments.

### DESCRIPTION OF PREFERRED EMBODIMENTS

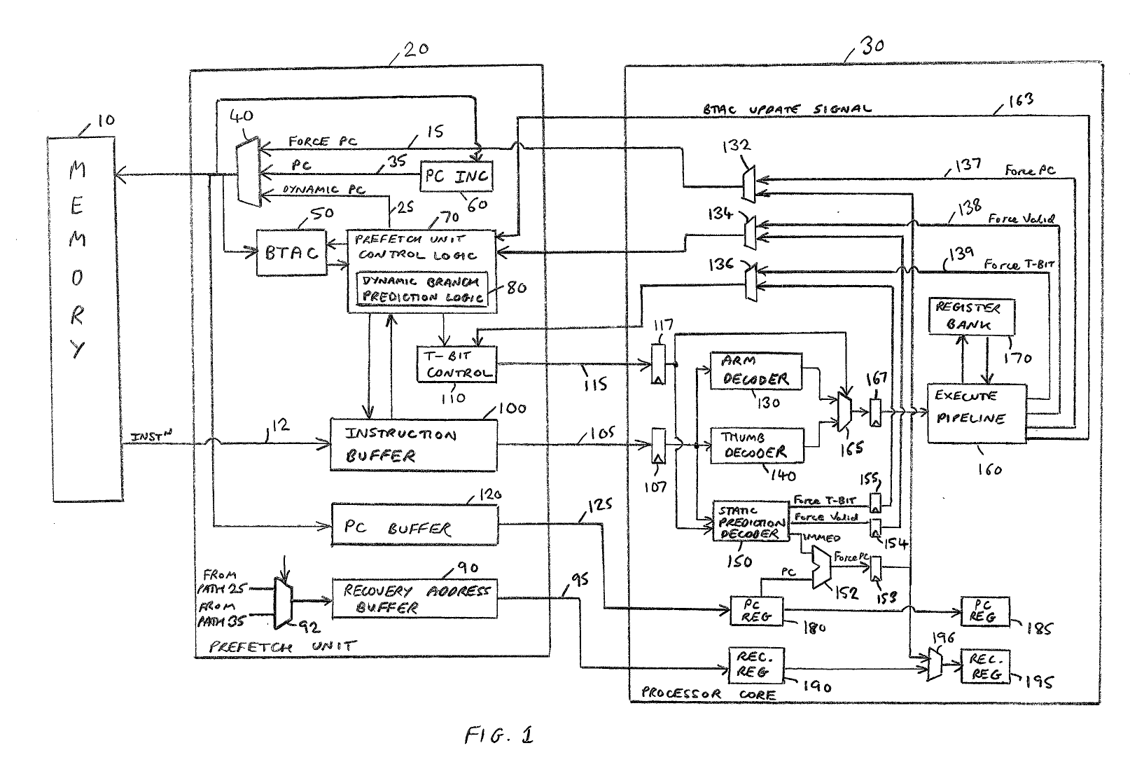

FIG. 1 is a block diagram of a data processing apparatus in accordance with an embodiment of the present invention. In accordance with this embodiment, the processor core 30 of the data processing apparatus is able to process instructions from two instruction sets. The first instruction set will be referred to hereafter as the ARM instruction set, whilst the second instruction set will be referred to hereafter as the Thumb instruction set. Typically, ARM instructions are 32-bits in length, whilst Thumb instructions are 16-bits in length. In accordance with preferred embodiments of the present invention, the processor core 30 is provided with a separate ARM decoder 130 and a separate Thumb decoder 140, which are both then coupled to a single execution pipeline 160 via a multiplexer 165.

When the data processing apparatus is initialised, for example following a reset, an address will typically be output by the execution pipeline 160 over path 137 as a forced program counter (Force PC) value, where it will be routed via multiplexer 132 over path 15 to an input to a multiplexer 40 of a prefetch unit 20. As will be discussed in more detail later, multiplexer 40 is also arranged to receive inputs over paths 25 and 35 from a dynamic branch prediction logic 80 and a program counter incrementer 60, respectively. However, the multiplexer 40 is arranged whenever an address is provided by the processor core 30 over path 15 to output that address to the memory 10 in preference to the inputs received over paths 25 or 35. This will result in the memory 10 retrieving the instruction specified by the address provided by the processor core, and then outputting that instruction to the instruction buffer 100 over path 12.

At the same time that the force PC value had been issued over path 137, a force valid signal will also be issued by the execute pipeline 160 over path 138, which will be routed via multiplexer 134 to the prefetch unit control logic 70 of the prefetch unit 20. In addition, a forced Thumb bit (or T bit) signal (Force T-bit) will be output by the execute pipeline 160 over path 139 to identify whether the instruction identified by the Force PC value on path 137 relates to an ARM instruction or a Thumb instruction. In preferred embodiments, the T bit signal will be set to a logic one value to indicate a Thumb instruction, and to a logic zero value to indicate an ARM instruction. The Force T bit signal on path 139 will be routed via the multiplexer 136 to the input of a T bit control circuit 110, where that T bit value will be stored such that it can subsequently be output in association with the corresponding instruction retrieved by the prefetch unit into the instruction buffer 100.

When a program counter value is output from the multiplexer 40 to the memory 10 to identify an instruction to be retrieved into the instruction buffer 100, that program counter (PC) value is also fed back to a PC incrementer 60, which is then arranged to increment that PC value to identify over path 35 the PC value for the next sequential instruction. This will be the default PC value to be output by the multiplexer 40 to identify the next instruction to be retrieved, in the absence of alternative PC values being received over paths 15 or 25. It should be noted that in preferred embodiments the incrementation applied by the PC incrementer 60 is dependent on whether the instruction specified by the currently issued address is an ARM instruction or a Thumb instruction. For an ARM instruction, the address is incremented by four in preferred embodiments, whilst for a Thumb instruction the address is incremented by two. The PC incrementer 60 is able to determine the type of the instruction associated with the address output by the multiplexer over path 40 by reference to the appropriate entry within the T-bit control logic 110.

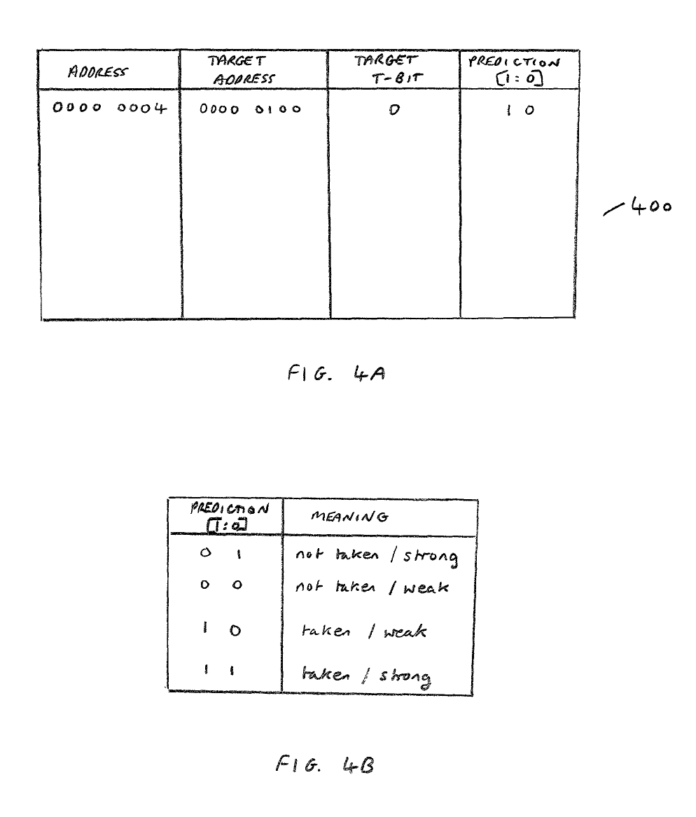

Within the prefetch unit 20, dynamic branch prediction logic 80 is provided to assist the prefetch unit in deciding what subsequent instructions to retrieve for the processor core 30. In preferred embodiments, this dynamic branch prediction logic 80 is provided as part of the prefetch unit control logic 70. Dynamic prediction uses historical information about what happened one or more previous times a particular branch operation was encountered to predict what will happen this time. In preferred embodiments that historical information is stored within the BTAC memory 50, details of what information is stored within the BTAC memory 50 in preferred embodiment being described later with reference to FIG. 4. When a program counter is issued by the multiplexer 40 to the memory 10 to cause a corresponding instruction to be retrieved into the instruction buffer 100, that program counter is also provided to the BTAC memory 50, where it is compared with the program counters of the various branch operations recorded within the BTAC memory. If the program counter matches one of the program counters for an entry in the BTAC memory, this indicates that the instruction currently being retrieved is a branch instruction, and that accordingly the dynamic branch prediction logic 80 should be used to predict whether that branch will be taken. Accordingly, the contents for the relevant entry within the BTAC memory 50 are output to the dynamic branch prediction logic 80 to enable that logic to determine whether the branch will be taken or not. As will be appreciated by those skilled in the art, many branch prediction schemes exist, and accordingly will not be discussed in further detail herein.

However, assuming the dynamic branch prediction logic 80 were to determine from the information provided by the BTAC memory 50 that the branch would be taken, it outputs as a dynamic PC value over path 25 the target address specified by the relevant entry in the BTAC memory 50 so as to cause the instruction at that target address to be the next instruction retrieved from the memory 10 and placed into the instruction buffer 100. At the same time, the dynamic branch prediction logic 80 will output to the T-bit control circuit 110 a T bit value identifying the T bit relevant to that instruction to be retrieved (the T bit being specified within the relevant entry of the BTAC memory 50).

In the event that the prediction is ultimately determined to be incorrect by the execute pipeline 160, it is clearly important to preserve the program counter value that should have been used instead. Accordingly, if the dynamic branch prediction logic 80 predicts that the branch will be taken, and accordingly issues a dynamic PC value over path 25, the current value within the PC incrementer 60 is routed as an input to a recovery address buffer 90 via path 35 and multiplexer 92, from where it is subsequently output in association with the retrieved instruction to identify the program counter that should be used in the event that the prediction subsequently proves wrong, and a recovery process is hence needed. Similarly, if the dynamic branch prediction logic 80 predicts that the branch will not be taken, then the target address is output to the recovery address buffer 90 via path 25 and multiplexer 92, since in this event the next instruction retrieved will be that as specified by the PC incrementer 60, and in the event that that prediction subsequently proves to be wrong, then it is clear that the instruction specified by the target address will need to be retrieved.

It should be noted that at startup there will be no history within the BTAC memory 50, and accordingly the dynamic branch prediction 80 is unable to perform any prediction of the initial instruction(s) retrieved into the instruction buffer 100.

As each instruction is output from the instruction buffer 100 to the processor core 30 over path 105, the corresponding T bit signal is output from the T bit control logic 110 over path 115 to identify to the processor core which instruction set the instruction belongs to. In addition, the PC value corresponding to that instruction is output from the PC buffer 120 over path 125, as can be seen from FIG. 1 the PC buffer 120 being arranged to receive each PC value output by the multiplexer 40 to the memory 10. Similarly, the corresponding recovery address is output over path 95 from the recovery address buffer 90.

The instruction and the T-bit signal output from the prefetch unit to the processor core are latched in latches or flops 107, 117, respectively. The instruction is then passed to the ARM decoder 130, the Thumb decoder 140, and a static prediction decoder 150. The T bit is output to a multiplexer 165, and also routed to the static prediction decoder 150. Using the input T bit signal, the multiplexer 165 can determine which of the outputs from the ARM decoder 130 and the Thumb decoder 140 to output to the latch 167. Hence, if the T bit is set to a logic one value, the output from the Thumb decoder 140 will be output to the latch 167, whereas if the T bit is set to a logic zero value, the output of the ARM decoder 130 will be output to the latch 167. As will be appreciated by those skilled in the art, both the ARM decoder 130 and the Thumb decoder 140 can be arranged to process each input instruction, as shown schematically in FIG. 1, or alternatively additional gating can be provided at the inputs to the ARM decoder and the Thumb decoder to ensure that only the appropriate decoder performs the decoding. This latter approach enables power savings to be achieved, since the unused decoder is not changing logic levels unnecessarily.

The static prediction decoder 150 is provided to perform predictions about the likely outcome of branch operations using only the information in the branch instruction itself Hence, the static prediction decoder 150 is arranged to receive the instruction and the corresponding T bit value, the T bit value enabling the static prediction decoder to identify whether the instruction is an ARM instruction or a Thumb instruction, and hence how to interpret the various bits of the instruction.

The static prediction decoder 150 of preferred embodiments works on the premise that backwards branches are typically found at the end of loops and are therefore taken more times than not taken, whereas forwards branches have a more even probability of being taken. Accordingly, the static prediction decoder 150 is arranged to predict backwards branches as taken and forward branches as not taken. Knowing this, compilers can design their forward branches so that they are more likely not to be taken.

There will also be certain branches that are unconditional, and accordingly will always be predicted as taken.

If the static prediction decoder 150 is to predict a branch as being taken, it needs to be able to determine the target address for the branch, and to be able to route that target address back to the prefetch unit to enable the instruction at that target address to be retrieved. If the target address is not uniquely identifiable by the static prediction decoder 150, for example because the target address is specified within the instruction by reference to a register of the register bank 170 that will contain the target address, then the static prediction decoder will be unable to predict such a branch. However, if the static prediction decoder 150 can uniquely identify the target address, for example because it is explicitly expressed within the branch instruction itself, then it can predict such branches.

In preferred embodiments, target addresses are preferably specified within a branch instruction as an offset value to be added to a program counter value, and accordingly the static prediction decoder 150 is arranged to be coupled to an adder 152 which is arranged to add such an offset value (or “immediate” value as it is also referred to herein) to the relevant program counter value as retrieved from the program counter register 180. This results in the generation of a forced program counter value (Force PC) to be issued to the latch 153. At the same time, a forced T bit (Force T-bit) signal will be issued to the latch 155 clarifying the T bit that is relevant to the instruction specified by the Force PC value in the latch 153. In addition, a Force valid signal will be issued to the latch 154 to specify that the signals in the latches 153 and 155 are valid.

As the Thumb instruction set comprises 16-bit instructions, then there is difficulty in providing a single branch instruction that will enable the required offset value to be specified directly within that branch instruction. This is due to there being insufficient free bits within the instruction to uniquely identify the offset value. One solution available to the programmer is to assemble a large immediate value in a register, this typically requiring at least two instructions, and to then branch to that register value, resulting in at least three instructions in total to specify the branch.

Alternatively, in the Thumb instruction set, two types of instruction, namely the Thumb BL (Branch with Link) and the Thumb BLX (1) (Branch with Link and Exchange) branch instructions are provided, each of these instructions actually consisting of a pair of instructions which can be executed independently, but which in combination specify a branch operation.

The first instruction of the pair will be referred to as the BL_{A} instruction and is arranged to perform the function:

r14=PC+immed1

(where “immedl” is specified by predetermined bits of the BL_{A} instruction)

The BL_{A} instruction is common to both the Thumb BL and the Thumb BLX (1) branch instructions.

The second instruction in the pair will be referred to herein as the BL_{B} instruction for the Thumb BL branch instruction, and BLX_{B} for the Thumb BLX (1) branch instruction. Both the BL_{B} and the BLX_{B} instructions performs the function:

PC=r14+shifted immed 2

(where “immed2” is specified by predetermined bits of the BL_{B} or BLX_{B} instruction)

The overall effect is: PC=PC+{immed2, immed1}. Both the BL_{B} and BLX_{B} instructions also put the subroutine return address in register r14.

The difference between the BL_{B} and the BLX_{B} instruction is that the BLX_{B} instruction can also cause a change in instruction set from the Thumb instruction set to the ARM instruction set.

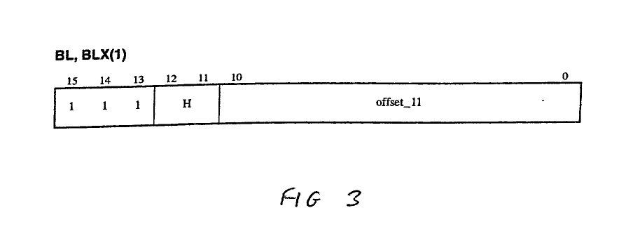

FIG. 3 illustrates the Thumb BL or the Thumb BLX (1) instruction. As mentioned earlier, the BL instruction provides an unconditional sub-routine call to another Thumb routine. The return from the sub-routine is typically performed by either making the contents of the register r14 the new program counter, or by branching to the address specified in register r14, or by executing an instruction to specifically load a new program counter value.

The BLX (1) form of the Thumb BLX instruction provides an unconditional subroutine call to an ARM routine. Again, the return from the sub-routine is typically performed by executing a branch instruction to branch to the address specified in register r14, or by executing a load instruction to load in a new program counter value.

To allow for a reasonably large offset to the target subroutine, each of these two branch instructions is automatically translated by the assembler into a sequence of two 16-bit Thumb instruction, as follows:

The first Thumb instruction, BL_{A}, has H=10 and supplies the high part of the branch offset. This instruction sets up for the subroutine call and is shared between the BL and BLX (1) forms.

The second Thumb instruction, BL_{B} or BLX_{B}, has H=11 (for BL) or H=01 (for BLX (1)). It supplies the low part of the branch offset and causes the subroutine call to take place.

The target address for the branch is in preferred embodiments calculated as follows:

1. Shifting the offset_{—}11 field (i.e. immed1) of the first instruction left twelve bits.

2. Sign-extending the result to 32 bits.

3. Adding this to the contents of the PC (which identifies the address of the first instruction).

4. Adding twice the offset_{—}11 field (i.e. immed2) of the second instruction.

For BLX (1), the resulting address is forced to be word-aligned by clearing bit[1].

The instruction can therefore in preferred embodiments specify a branch of approximately ±4 MB.

Accordingly, returning to FIG. 1, if the static prediction decoder 150 reviews bits 11 to 15 of a candidate Thumb branch instruction, and determines that bits 13 to 15 are “111” whilst bits 11 and 12 are “10” then the static prediction decoder 150 will conclude that this is the first of two instructions specifying the branch. If when reviewing the next instruction, it is determined that bits 13 to 15 are “111” and bits 11 and 12 are “11” then the static prediction decoder 150 will determine that a Thumb BL branch instruction is present, whereas if it is determined that bits 13 to 15 are “111” and bits 11 and 12 of the next instruction are “01”, the static prediction decoder 150 will determine that a Thumb BLX (1) branch instruction is present.

In either case, the static prediction decoder 150 will cause an appropriate “immediate” value to be output to the adder 152, to cause the adder to output the target address for the branch as a Force PC value for storing in the latch 153. At the same time, the static prediction decoder 150 will cause a Force T-bit signal to be output for storing in latch 155, to indicate the value of the T bit appropriate for the instruction at the target address. For example, in the event that the static prediction decoder 150 determines the presence of a Thumb BL branch instruction, the instruction set will not change, and accordingly the Force T-bit signal will indicate that the T-bit is one. However, if the static prediction decoder 150 detects the presence of the Thumb BLX (1) branch instruction, this results in a change of instruction set to the ARM instruction set, and accordingly the T bit will be specified as zero within the Force T-bit signal.

Finally, the static prediction decoder 150 also outputs a Force valid signal for storing in the latch 154, to indicate whether the values stored in the latches 155 and 153 are valid. Hence, as an example, if the static prediction decoder 150 predicted that the branch would not be taken, it would set the Force valid signal to indicate that the output values were invalid. However, in preferred embodiments, both the Thumb BL and the Thumb BLX (1) branch instructions are unconditional, and accordingly if the static prediction decoder 150 does detect the presence of those instructions, it will predict the branches taken, and will hence issue a Force valid signal indicating that the outputs are valid.

Nevertheless, if the Thumb BL_{B} or the Thumb BLX_{B} instructions do not immediately follow the Thumb BL_{A} instruction, then in preferred embodiments the static prediction decoder 150 is arranged to issue a Force valid signal indicating that the outputs are invalid, since there can be no certainty that the immediate value output by the static prediction decoder 150 is in fact accurate. This is due to the fact that the static prediction decoder is arranged to temporarily store the immediate value (immed1) provided within the BL_{A} instruction for subsequent use in working out the immediate value to be output to the adder 152 upon receipt of the BL_{B} or BLX_{B} instruction, and in the event that there are any intervening instructions the static prediction decoder 150 can no longer be sure that that temporarily stored value has not been altered. Accordingly, in preferred embodiments, the static prediction decoder 150 will not predict Thumb BL or Thumb BLX (1) instructions in the event that the two constituent instructions are not executed sequentially.

It should be noted that with regard to the actual execution of these instructions without prediction, there is no requirement that the pair of instructions making up either the Thumb BL instruction or the Thumb BLX (1) instruction should be executed one immediately after the other, since the result of the BL_{A} instruction is stored into the register r14, and it can be ensured by the programmer that this value is not corrupted by any intervening instructions, for example an interrupt.

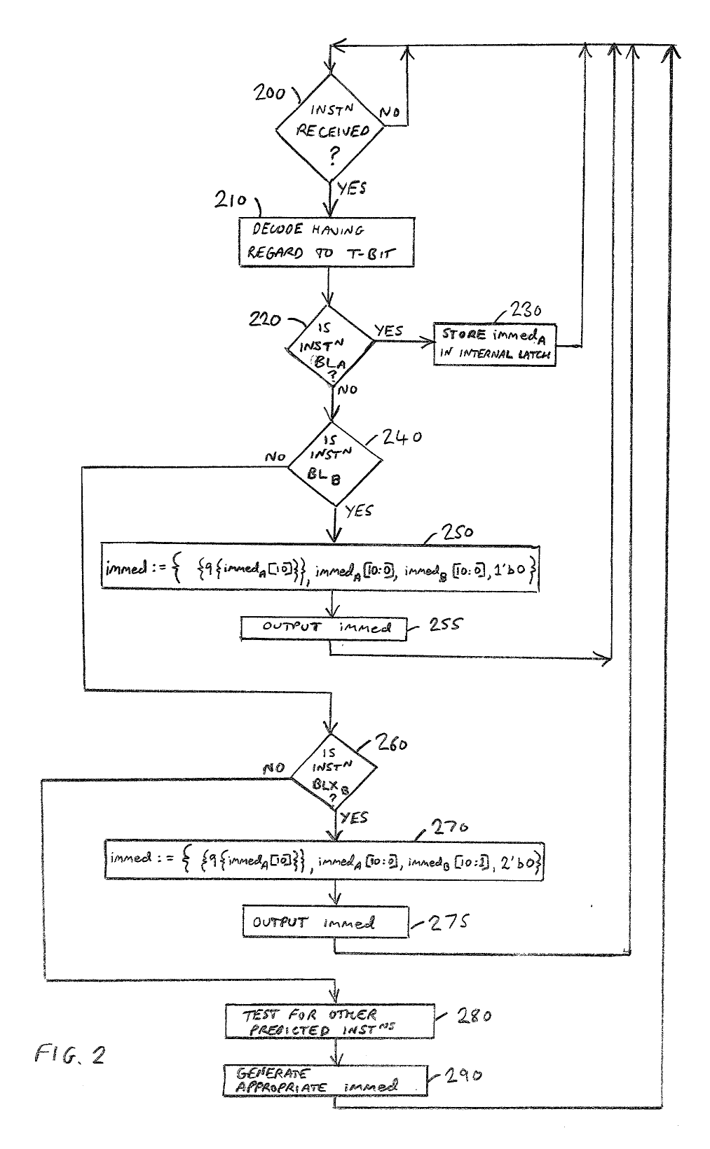

FIG. 2 is a flow diagram illustrating in more detail the process performed within the static prediction decoder 150 in order to calculate the immediate value to output to the adder 152. At step 200 it is determined whether an instruction has been received by the static prediction decoder 150. Once an instruction is received, the process proceeds to step 210, where that instruction is decoded having regard to the T-bit signal received from latch 117. The static prediction decoder 150 needs to know from which instruction set the instruction belongs, so that it can correctly decode the relevant bits of the instruction. Once the decoding has taken place, the static prediction decoder 150 will then test for a variety of branch instructions that it is arranged to predict. Typically, these tests may be considered as being carried out in parallel. However for sake of illustration in FIG. 2, these tests are shown sequentially as steps 220, 240, 260, 280.

Hence, at step 220, it is determined whether the decoded instruction is a BL_{A} instruction, and if so the process proceeds to step 230, where the immediate value specified within that BL_{A} instruction (referred to hereafter as immed_{A}) is stored in an internal latch. With reference to FIG. 3, it can be seen that this immed_{A} value consists of bits 10 to 0 of the BL_{A} instruction. The process then returns to step 200 to await receipt of the next instruction. If at step 220, it is determined that the instruction is not a BL_{A} instruction, the process then proceeds to step 240, where it is determined whether the instruction is a BL_{B} instruction. If that instruction is a BL_{B} instruction, then the process proceeds to step 250, where the immediate value to be output to the adder 152 is calculated in accordance with the expression set out in box 250. In this expression, immed_{A} is the immediate of the preceding BL_{A} instruction that will already have been stored at step 230, while immed_{B} is the immediate of the BL_{B} instruction (i.e. bits 10 to 0 of the BL_{B} instruction). As can be seen from box 250, the most significant nine bits of the immediate value are set equal to bit 10 of immed_{A}, after which all 11 bits of immed_{A} are then reproduced, followed by all 11 bits of immed_{B}, followed by a final bit set equal to binary 0. Hence, it will be appreciated that this 32-bit immediate value is obtained by a process equivalent to shifting the immed_{A} value left by 12 bits, sign extending the result to 32 bits, and then adding twice the immed_{B} value to the shifted result.

The resulting immediate value is then output at step 255 to the adder 152, where it is added to the PC value of the BL_{A} instruction to generate the target address. It can hence be seen that this process results in an absolute determination of the target address without requiring any reference to register r14 as is required when the pair of instructions are actually executed by the execute pipeline 160.

If at step 240 it is determined that the instruction is not the BL_{B} instruction, the process then proceeds to step 260, where it is determined whether the instruction is the BLX_{B} instruction. If so, the immediate value is calculated at step 270, the immediate value being given by the expression set out in box 270. As can be seen from box 270, the immediate value is basically the same as the immediate value calculated for the BL_{B} instruction at step 250, with the exception that the resulting ForcePC value is forced to be word-aligned by clearing bit[1].

The resulting immediate value is then output at step 275 for use by the adder 152 in generating the target address. Again, the target address is formed by adding the PC value of the BL_{A} instruction to the calculated immediate value.

If at step 260 it is determined that the instruction is not the BLX_{B} instruction, then the process proceeds to step 280, where any other tests for other predicted branch instructions are performed, in association with generation of any appropriate immediate value at step 290.

Returning to FIG. 1, the values stored in latches 155, 154 and 153 are then routed to multiplexers 136, 134 and 132, respectively, from where they are then routed back to the prefetch unit 20. More specifically, the Force valid signal is routed via multiplexer 134 to the prefetch unit control logic 70, the Force PC value is routed via the multiplexer 132 to the multiplexer 40, and the Force T-bit signal is routed via the multiplexer 136 to the T-bit control circuit 110. In the event that the Force valid signal indicates that the other signals are valid, the prefetch unit control logic will cause all of the pending instructions in the instruction buffer 100 to be flushed, will cause the multiplexer 40 to output as the next address to memory 10 the Force PC value as received from multiplexer 132, and will also cause the T-bit control circuit to store as the T-bit value for the corresponding instruction being retrieved from memory the T-bit expressed by the Force T-bit signal. Further, the processor core 30 performs any internal flushing required when it asserts the Force valid signal.

Whilst this is happening, the actual instruction sequence will have been output from the latch 167 into the execute pipeline 160 and will accordingly be executed. Although not shown explicitly in FIG. 1, various control signals will be passed through the execute pipeline 160 in association with each instruction to indicate whether any prediction of that instruction has been made by either the static prediction decoder 150 or the dynamic branch prediction logic 80.

When a particular branch instruction reaches the execute pipeline, the execute pipeline 160 will determine at a certain point during execution (also referred to herein as the commit point) whether that branch is to be taken or not taken, based on the actual condition codes at that time. This process performed by the execute pipeline is also known as branch resolution. Hence, considering the example of a conditional branch instruction, it is possible that either the static prediction decoder 150 or the dynamic branch prediction logic 80 will have predicted the branch as taken, whereas evaluation by the execute pipeline 160 at the relevant commit point may indicate that the branch should not be taken. This will mean that the instructions retrieved by the prefetch unit in dependence on the prediction that the branch will be taken will not be required, and instead the execute pipeline 160 will need to output a Force PC, Force valid and Force T-bit sequence of signals over paths 137, 138 and 139, respectively, indicating the target address for the instruction that should in fact be retrieved from the memory for execution next by the execute pipeline 160.

The value of the Force PC signal to be output by the execute pipeline 160 in such an instance is actually determined by the execute pipeline 160 from the contents of the recovery register 195, as mentioned earlier this information having been passed through the pipeline from the recovery address buffer 90. The Force PC, Force valid and Force T-bit signals are routed via multiplexers 132, 134 and 136 to the prefetch unit 20. More particularly, the Force valid signal is routed via the multiplexer 134 to the prefetch unit control logic 70, which will then cause the prefetch unit control logic 70 to flush all of the pending instructions from the instruction buffer 100, and to instruct the multiplexer 40 to output to the memory 10 the Force PC value received from multiplexer 132. Further, the prefetch unit control logic 70 will instruct the T-bit control logic 110 to store as the T-bit for the instruction now being retrieved the T-bit as specified by the Force T-bit signal received from multiplexer 136.

Within the processor core 30, all pending instructions in the pipeline 160 and the decoders 130, 140, 150 will also be flushed, such that the next instruction executed will be the instruction specified by the Force PC value issued by the execute pipeline over path 137.

A similar process will also occur if either the static prediction decoder 150 or the dynamic branch prediction logic 80 have predicted the branch as not being taken, and subsequently the execute pipeline 160 determines that the branch should in fact be taken. The execute pipeline 160 then needs to issue as the Force PC value on path 137 the target address for the branch. In the event that the dynamic branch prediction logic 80 had predicted the branch as not taken, the relevant target address will have been placed in the recovery address buffer 90 at the time of dynamic branch prediction. However, if the static prediction decoder 150 predicts the branch as not taken, then the target address latched within latch 153 is routed to a multiplexer 196, which in the event that the branch is predicted as not taken, causes that target address to be input into the recovery register 195, so that that target address is then available for the execute pipeline 160.

In preferred embodiments, both the Thumb BL and the Thumb BLX (1) instructions are unconditional, and accordingly, if either the dynamic branch prediction logic 80 or the static prediction decoder 150 have predicted those branches as taken, the execute pipeline will also typically determine the branches as taken.

Whenever the execute pipeline 160 resolves a branch at the commit point, then it is arranged to issue a BTAC update signal via path 163 to the prefetch unit control logic 70, this update signal providing information about the branch, and whether it was or was not taken. This information is then used by the prefetch unit control logic 70 to update the BTAC 50. In the event that the branch instruction corresponding to the BTAC update signal already has an entry in the BTAC 50, then this will result in merely updating the relevant entry to reflect the new history information. However, in the event that the branch instruction corresponding to the BTAC update signal is a branch instruction which does not yet have an entry in the BTAC, then this will result in a new entry being added to the BTAC 50 to represent that branch instruction and the history information now available. As discussed previously, when that branch instruction is next retrieved from the memory 10 into the instruction buffer, the dynamic branch prediction logic 80 can at the same time make a branch prediction based on the contents of the corresponding entry in the BTAC 50 so that in the event that the branch is predicted as taken, the target address can be output as the dynamic PC value over path 25, or alternatively if the branch is predicted as not taken, the dynamic PC value can be routed to the recovery address buffer 90, whilst the normal PC incremented value on path 35 is used as the PC value for the next instruction.

In preferred embodiments, the BTAC memory 50 can only store information about branch instructions for which the target address is uniquely identifiable from the instruction itself, as it is only in those circumstances that the dynamic branch prediction logic 80 can make a prediction about the branch instruction (this implicitly involving the issuance of a target address if the branch is to be predicted as taken). For the Thumb BL and BLX (1) instructions, it is the second instruction in each pair of instructions that actually specifies a branch, the BL_{A} instruction merely generating an intermediate value for storing in register r14 for use by the second instruction in the pair. Prior to the present invention, it would not be possible for the execute pipeline 160 to issue a BTAC update signal for either the BL_{B} or the BLX_{B} instruction, since these instructions calculate the target address with reference to the contents of register r14, and accordingly do not appear to meet the requirements that the target address is uniquely derivable from the branch instruction itself.

However, as previously described, the static prediction decoder 150 of preferred embodiments in effect stitches together the relevant parts of each pair of instructions, with the result that a unique target address is determined by the static prediction decoder 150. Accordingly, when the commit point of either the BL_{B} or the BLX_{B} instruction is reached within the execute pipeline 160, the execute pipeline 160 can determine the branch as taken, generate the relevant the T-bit value, obtain the unique target address as generated by the static prediction decoder 150 in combination with the adder 152, and use this information to generate a BTAC update signal for issuance over path 163. It should be noted that since both the Thumb BL and the Thumb BLX (1) instructions are unconditional, then if they have been correctly predicted by the dynamic branch prediction logic 80 or the static prediction decoder 150, then the execute pipeline 160 will not need to perform the actual calculation specified by those instructions, and will not need to issue any corrective Force signals over paths 137, 138 and 139.

In preferred embodiments, it is envisaged that the first occurrence of the Thumb BL or the Thumb BLX (1) instruction will be predicted by the static prediction decoder 150. In preferred embodiments, the first occurrence predicted will have to be an occurrence in which the pair of instructions constituting either the Thumb BL or BLX (1) branch instruction are consecutive within the instruction sequence, for the reasons discussed earlier. Once the first occurrence has been predicted by the static prediction decoder 150, then at the time that first occurrence subsequently gets executed within the execute pipeline 160, this will cause a BTAC update signal 163 to be generated to cause information about that branch instruction to be placed within the BTAC 50. It is then envisaged that each subsequent occurrence of the Thumb BL or Thumb BLX (1) instructions will be predicted by the dynamic branch prediction logic 80. Further, each time these instructions reach the execute pipeline 160, a further BTAC update signal will be issued to cause the relevant history information for these instructions to be updated within the BTAC 50.

FIG. 4A is a diagram schematically illustrating the fields provided for each entry within the BTAC 50 in preferred embodiments. The four basic entries used in preferred embodiments are address (i.e. the address of the branch instruction), the target address specified by the branch instruction, the target T-bit (i.e. the T bit relevant to the instruction specified by the target address), and prediction, or history, information. In the example of the Thumb BL or Thumb BLX (1) instructions, it is the address of the BL_{B} or BLX_{B} instruction that will be placed within the relevant entry of the BTAC 50, since it is the second of the pair of instructions forming either the Thumb BL or the Thumb BLX (1) instruction that performs the actual branch.

FIG. 4B provides an illustration of the meaning attributed to the prediction information in preferred embodiments, in preferred embodiments the prediction information consisting of two bits. When a particular branch instruction is first predicted, it will be predicted as either taken or not taken. If it is predicted as taken, the prediction bits will be set to “10” indicating that the dynamic branch prediction logic 80 should predict the next occurrence of that branch instruction as weakly taken. Similarly, if the first occurrence is predicted as not taken, then the prediction bits are set to “00” to indicate that the dynamic branch prediction logic 80 should predict the next occurrence of that branch instruction as weakly not taken.

Considering the example where the first branch instruction is taken, and hence the prediction bits are set to “10”, if the next occurrence of that branch instruction is actually determined by the execute pipeline 160 to be taken again, then the BTAC update signal 163 will cause the prediction bits to be updated to the values “11”, which will now indicate to the dynamic branch prediction logic that the next occurrence should be predicted as strongly taken. Similarly, if instead the execute pipeline 160 were to detect that the next occurrence were not taken, then the BTAC update signal 163 would cause the prediction bits to be updated from “10” to “00”, indicating that the dynamic branch prediction logic 80 should predict the next occurrence as weakly not taken. The use of the two bits of prediction information has been found to be particularly efficient, since it means that the decision taken by the dynamic branch prediction logic is not solely influenced by the last occurrence of the branch instruction, and hence allows the dynamic branch prediction logic 80 to more accurately follow trends.

The BTAC memory 50 in preferred embodiments is formed like a cache, and accordingly any of the many known techniques for managing caches can be used to manage the entries of the BTAC. For example, any known cache eviction scheme can be used to determine which entry or entries should be discarded in the event that a new entry needs to be made and the BTAC is already full.

Although a particular embodiment of the invention has been described herein, it will be apparent that the invention is not limited thereto, and that many modifications and additions may be made within the scope of the invention. For example, various combinations of the features of the following dependent claims could be made with the features of the independent claims without departing from the scope of the present invention.

We claim:

1. A data processing apparatus, comprising:
a processor for executing instructions;
a prefetch unit for prefetching instructions from a memory prior to sending those instructions to the processor for execution;
branch prediction logic for predicting which instructions should be prefetched by the prefetch unit, the branch prediction logic being arranged to predict whether a prefetched instruction specifies a branch operation that will cause a change in instruction flow, and if so to indicate to the prefetch unit a target address within said memory from which a next instruction should be retrieved;
the instructions including a first instruction and a second instruction that are executable independently by the processor, but which in combination specify a predetermined branch operation whose target address is uniquely derivable from a combination of attributes of the first and second instruction, the data processing apparatus further comprising:
target address logic for deriving from said combination of attributes the target address for the predetermined branch operation;
the branch prediction logic being arranged to predict whether the predetermined branch operation will cause a change in instruction flow, in which event the branch prediction logic is arranged to indicate to the prefetch unit the target address determined by the target address logic.

2. A data processing apparatus as claimed in claim 1, wherein the combination of attributes comprises the address of the first instruction and predetermined operands of the first and second instructions, the address of the first instruction being specified by a program counter value, and the target address logic including adder logic for generating the target address by adding the program counter value to an offset value derived from the predetermined operands of the first and second instructions.

3. A data processing apparatus as claimed in claim 2, wherein the target address logic is arranged to use the predetermined operands of one of the first and second instructions in the determination of the most significant bits of the offset value, and to use the predetermined operands of the other of the first and second instructions in the determination of the least significant bits of the offset value.

4. A data processing apparatus as claimed in claim 3, wherein the predetermined operands of the first instruction are used in the determination of the most significant bits of the offset value, and the target address logic is arranged to shift the predetermined operands of the first instruction left by a predetermined number of bits to produce a first value, to sign extend the first value to produce a second value having the same number of bits as the program counter, and to add the predetermined operands of the second instruction to the second value to produce a third value from which the offset value is derived.

5. A data processing apparatus as claimed in claim 2, wherein the target address logic is arranged upon occurrence of the first instruction to store the predetermined operands of the first instruction, and if the instruction following the first instruction is the second instruction, to then generate the target address.

6. A data processing apparatus as claimed in claim 1, wherein the branch prediction logic comprises a static branch prediction logic, the static branch prediction logic incorporating the target address logic.

7. A data processing apparatus as claimed in claim 6, wherein the processor is a pipelined processor of a processor core, the static branch prediction logic being located within the processor core such that it is arranged to issue the target address to the prefetch unit prior to committed execution of the second instruction by the processor.

8. A data processing apparatus as claimed in claim 1, further comprising a branch target cache for storing predetermined information about branch operations executed by the processor, the predetermined information including an identification of an instruction specifying a branch operation and a target address for the branch operation, the branch prediction logic comprising dynamic branch prediction logic arranged to determine with reference to the branch target cache whether a prefetched instruction is identified within the branch target cache, to predict whether that prefetched instruction specifies a branch operation that will cause a change in instruction flow, and if so to indicate to the prefetch unit the target address as specified in the branch target cache.

9. A data processing apparatus as claimed in claim 8, wherein upon committed execution of said second instruction by the processor, the processor is arranged to issue a branch target cache signal identifying the predetermined information about the predetermined branch operation to cause an update of the branch target cache to take place, the processor being arranged to obtain the target address from the target address logic for inclusion in the branch target cache signal.

10. A data processing apparatus as claimed in claim 8, wherein the branch target cache includes for each branch operation identified within the branch target cache historical information about previous execution of that branch operation by the processor for use by the dynamic prediction logic in predicting whether that branch operation will cause a change in instruction flow.

11. A data processing apparatus as claimed in claim 8, wherein said dynamic branch prediction logic is contained within said prefetch unit.

12. A data processing apparatus as claimed in claim 8, wherein the branch prediction logic further comprises a static branch prediction logic, the static branch prediction logic incorporating the target address logic.

13. A data processing apparatus as claimed in claim 12, wherein the processor is a pipelined processor of a processor core, the static branch prediction logic being located within the processor core such that it is arranged to issue the target address to the prefetch unit prior to committed execution of the second instruction by the processor.

14. A method of predicting which instructions should be prefetched by a prefetch unit of a data processing apparatus, the data processing apparatus having a processor for executing instructions, and said prefetch unit being arranged to prefetch instructions from a memory prior to sending those instructions to the processor for execution, the instructions including a first instruction and a second instruction that are executable independently by the processor, but which in combination specify a predetermined branch operation whose target address is uniquely derivable from a combination of attributes of the first and second instruction, the target address specifying an address within said memory from which a next instruction should be retrieved, and the method comprising the steps of:
i) deriving from said combination of attributes the target address for the predetermined branch operation;
ii) predicting whether the predetermined branch operation will cause a change in instruction flow; and
iii) if it is predicted at said step (ii) that the predetermined branch operation will cause a change in instruction flow, indicating to the prefetch unit the target address determined at said step (i).

15. A method as claimed in claim 14, wherein the combination of attributes comprises the address of the first instruction and predetermined operands of the first and second instructions, the address of the first instruction being specified by a program counter value, and said step (i) comprising the step of generating the target address by adding the program counter value to an offset value derived from the predetermined operands of the first and second instructions.

16. A method as claimed in claim 15, wherein in said step (i), the predetermined operands of one of the first and second instructions are used in the determination of the most significant bits of the offset value, and the predetermined operands of the other of the first and second instructions are used in the determination of the least significant bits of the offset value.

17. A method as claimed in claim 16, wherein the predetermined operands of the first instruction are used in the determination of the most significant bits of the offset value, and said step (i) comprises the steps of:
shifting the predetermined operands of the first instruction left by a predetermined number of bits to produce a first value;
sign extending the first value to produce a second value having the same number of bits as the program counter; and
adding the predetermined operands of the second instruction to the second value to produce a third value from which the offset value is derived.

18. A method as claimed in claim 15, further comprising the step, prior to said step (i) of, upon occurrence of the first instruction, storing the predetermined operands of the first instruction, and if the instruction following the first instruction is the second instruction, then performing said step (i) to generate the target address.

19. A method as claimed in claim 14, wherein said steps (i) to (iii) are performed within a static branch prediction logic of the data processing apparatus.

20. A method as claimed in claim 19, wherein the processor is a pipelined processor of a processor core, the static branch prediction logic being located within the processor core such that it is arranged to issue the target address to the prefetch unit prior to committed execution of the second instruction by the processor.

21. A method as claimed in claim 14, wherein the data processing apparatus further comprising a branch target cache for storing predetermined information about branch operations executed by the processor, the predetermined information including an identification of an instruction specifying a branch operation and a target address for the branch operation, the data processing apparatus further comprising dynamic branch prediction logic arranged to perform the steps of:
determining with reference to the branch target cache whether a prefetched instruction is identified within the branch target cache;
predicting whether that prefetched instruction specifies a branch operation that will cause a change in instruction flow; and
if so, indicating to the prefetch unit the target address as specified in the branch target cache.

22. A method as claimed in claim 21, wherein upon committed execution of said second instruction by the processor, the processor is arranged to perform the step of issuing a branch target cache signal identifying the predetermined information about the predetermined branch operation to cause an update of the branch target cache to take place, the processor receiving the target address as derived at said step (i) for inclusion in the branch target cache signal.

23. A method as claimed in claim 21, wherein the branch target cache includes for each branch operation identified within the branch target cache historical information about previous execution of that branch operation by the processor for use by the dynamic prediction logic in predicting whether that branch operation will cause a change in instruction flow.

24. A method as claimed in claim 21, wherein said dynamic branch prediction logic is contained within said prefetch unit.

25. A method as claimed in claim 21, wherein the data processing apparatus further comprises a static branch prediction logic, the static branch prediction logic being arranged to perform said steps (i) to (iii).

26. A method as claimed in claim 25, wherein the processor is a pipelined processor of a processor core, the static branch prediction logic being located within the processor core such that it is arranged to issue the target address to the prefetch unit prior to committed execution of the second instruction by the processor.
